(19) United States
(12) Patent Application Publication
(10) Pub. No.: US 2007/0147620 A1
(43) Pub. Date: Jun. 28, 2007

(54) Method for encryption key management for use in a wireless mesh network

(76) Inventors: Heyun Zheng, DeBary, FL (US); Charles R. Barker JR., Orlando, FL (US); Surong Zeng, Altamonte Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/320,380

(22) Filed: Dec. 28, 2005

(51) Int. Cl. H04L 9/00

(52) U.S. Cl. 380/277

(57) ABSTRACT

A method for managing secure routing keys (200) for on-demand routing protocols used in a wireless mesh network includes sending an secure routing key from a key distribution node to an access node (201). A temporary communications route which is time and usage limited is initiated (203) between a wireless device and an internet access point when the wireless device initially joins the network. A secure routing key is sent (205) from the internet access point connected with the key distribution center to the wireless device. Thereafter, the secure routing operation can be started to establish secure routes among all wireless devices which have obtained the same secure routing key in the same manner. Thus, the invention defines a simple and efficient key management technique using initial key establishment and re-keying through dynamically updated key vectors.

### FIELD OF THE INVENTION

The present invention relates to routing security and more particularly to secure routing key management for on-demand routing protocols in the infrastructure-based multi-hop wireless network works.

### BACKGROUND

As wireless communications networks become more prevalent, security continues to be a major concern to both communication network providers and end users. This is most evident when using a mobile wireless network where the security environment can offer the greatest challenges since data may be readily received and manipulated by many nodes. One focus of the concern is on routing security where the goal is to prevent a malicious user or “hacker” from attempting to disrupt data path routing functions or to cause legitimate data packets to be incorrectly routed.

Many designs and security schemes have been proposed to secure network routing protocols. In those schemes, each device proactively signs its routing messages using cryptographic functions. These include such methods as a message authentication code using a symmetric key algorithm or a digital signature via an asymmetric key algorithm. These methods allow collaborative devices to efficiently authenticate any legitimate routing information. The most difficult part of this problem is in finding a simple but secure key management mechanism. Known prior art solutions such as pre-set private keys or public key pairs in each participating device are difficult to implement since they require re-keying and maintaining related support facilities such public key infrastructure (PKI). Accordingly, a new and less complex approach is needed for secure routing key management.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is block diagram illustrating an infrastructure based multi-hop wireless network in accordance with an embodiment of the invention.

FIG. 2 is a diagram illustrating set-up of a temporary route and exchange of a key management message in accordance with an embodiment of the invention.

FIG. 3 is a diagram illustrating the format of a routing message with a security extension in accordance with an embodiment the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to key management for secure on-demand routing protocols for use in a wireless mesh network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of key management for secure on-demand routing protocols for use in a wireless mesh network described herein. The non-processor circuits may include, but are not limited to, a radio receiver, a radio transmitter, signal drivers, clock circuits, power source circuits, and user input devices. As such, these functions may be interpreted as steps of a method to perform to key management for secure on-demand routing protocols for use in a wireless mesh network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In recent years, mobile wireless networks have received tremendous attention in the fields of public safety and intelligent transportation systems as well as in other industrial applications. In most of these deployments, access to the wired networks is needed. Even for the peer-to-peer applications where a mobile wireless device communicates with another mobile wireless device, the wired infrastructure may still be needed for improving the performance by reducing wireless hops of two far apart communicating wireless devices. In the design of such multi-hop wireless networks, all mobile wireless devices will maintain continuous connectivity with an Internet Access Point (IAP) through either a wireless router or other mobile wireless devices. Therefore, the performance of the communication between wired networks and mobile wireless devices, or mobile wireless devices to distant mobile wireless devices, can be significantly improved.

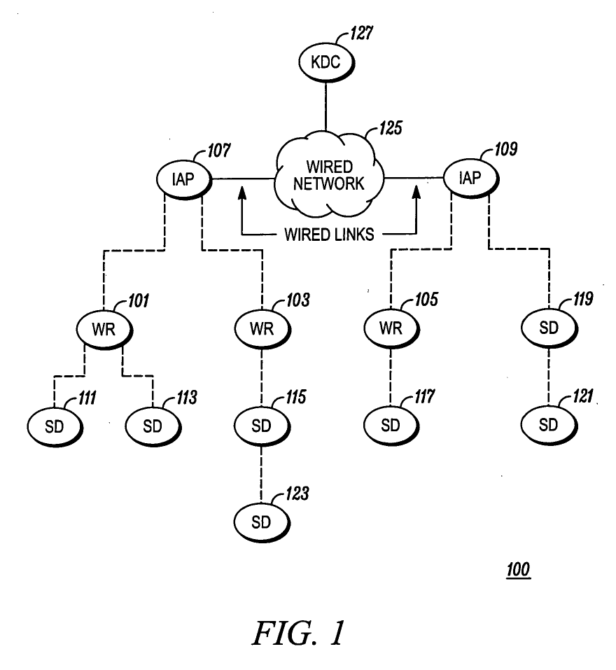

Turning now to FIG. 1, a block diagram illustrates an example of an infrastructure-based mobile wireless network 100. The wireless routers 101, 103, 105 (WR) are used to route the packets from an internet access point 107, 109 (IAP) to one or more wireless subscriber devices 111-123 (SD). Only the paths from subscriber devices (SD) to the wired network 125 are shown. Meshed connections can be established as long as two neighboring devices such as subscriber device 111 and subscriber device 113 can communicate with one another. The key distribution center 127 (KDC) works to distribute secure routing keys and will be described hereinafter. The subscriber devices in the network may be required to send and receive encrypted data. There are generally two types of approaches to encrypting data traffic over such a network. These include hop-by-hop protection and end-to-end protection.

In hop-by-hop encryption, the data is decrypted and re-encrypted in each intermediate device as it travels through the network. In contrast, end-to-end encryption involves encrypting data traffic only at the original source device and decrypting in the final destination device within a wireless transmission region. In hop-by-hop protection, data and routing packets can be secured with the same security association between any neighboring devices. This might be viewed as the establishment of security before the routing procedure. However, this approach will inevitably introduce unnecessary delay in both normal data transmission and the hand-off process when the data route is changed. It also restricts the intermediate nodes to only the trusted devices in regard to the two communication end devices.

In the end-to-end encryption, the data is only encrypted in the source and decrypted in the destination. The encrypted packets are forwarded in the intermediate devices along the path without any security processing. Since the routing information is needed before the data packets can be transported, if using end-to-end protection, it is necessary and preferable to separate data security and routing security with different designs. Both of these processes have different security requirements since they address different threats in the network. Moreover, a route must first be found before devices which are at least two multi-hops away can initiate a security association and negotiation message exchange which is used to establish data protection. If a separate routing security mechanism is in place, the end-to-end data traffic security protection will be the more desirable approach compared to the hop-to-hop encryption techniques.

With regard to an on-demand routing protocol and its vulnerability, there are various types of routing protocols that can be used in such wireless mesh networks. On-demand routing protocols such as dynamic source routing protocol (DSR), ad hoc on-demand distance vector (AODV) and their variants are popular in these types of networks due to their low overhead and simplicity. On-demand routing protocols create routes only when desired by the source node. When a node requires a route to a destination, it initiates a route discovery process within the network. This process is completed once a route is found or all possible route permutations have been examined. Once a route has been established, it is maintained by some form of a route maintenance procedure until either the destination becomes inaccessible (along every path from the source) or until the route is no longer desired. Compared to “proactive” routing protocols, on-demand routing protocols have lower routing overhead and work more effectively in complex mobile environments. Thus, the present invention operates to secure the on-demand routing protocols including its variances. This would include such protocols as the hybrid routing protocol for mesh scalable routing as described in published United States Patent Publication Number 2004/0143842, by Avinash Joshi entitled “System and Method For Achieving Continuous Connectivity to an Access Point or Gateway in a Wireless Network Following an On-demand Routing Protocol and to Perform Smooth Handoff of Mobile Terminals between Fixed Terminals in the Network,” which is herein incorporated by reference in its entirety.

A number of routing messages are typically used in an on-demand routing protocol. These include route request (RREQ), route reply (RREP), route error (RERR), and a “hello” message. During the routing discovery phase, a route request is broadcast to all nodes. The nodes receiving the request can rebroadcast it if it is not the destination node as specified in the message or does not have a valid route to the destination. A route reply will be sent back to the originator in the destination node or in an intermediate node which has a valid route to the destination. The route request and reply messages have a field hop count which will control how far the route message will travel. They may also have a field called a routing metric which is used to collect the total routing cost for the route. A route error message is then used to inform upstream nodes in a route that the destination in the route has become unreachable. A “hello” message is also used to discover neighbors and related link metric.

There are many ways in which a malicious user can disrupt these normal on-demand routing procedures. These include but are not limited to:

1) sending false route error messages in order to eliminate the working routes;

2) sending false route reply messages in order to wage selective forwarding or sinkhole attack; and

3) modifying the routing messages with incorrect routing information.

In such a potentially unfriendly environment, it is desirable to add security protection to the routing protocol. Two such security properties are message origination protection and content integrity which shall minimize the impacts of forging and modification in the protocol. These two properties can be acquired if a same symmetric key is made available to the routing protocol participating devices. A security extension can be added to each routing message and detection of the attack then can be possible. There are several components in the key management scheme for secure routing protocols of the present invention, these include:

1) two types of routes are defined: secured and temporary routes;

2) different processing procedures for routing messages with different risk levels;

3) a central key distribution server located in the wired network; and

4) an indexed key model to allow for a flexible re-keying operation.

In operation, a secured route is defined as a route which is established through secured routing message exchange. The secured route is used for both user data traffic and control/management traffic in the network. A temporary route is a route that is established through an unsecured routing message exchange, and is identified with a special flag or indication in the route table. The temporary route has a limited life time and is only used for authentication and key management messages when a wireless device joins the network initially for the first time. The temporary routes may be established only upon certain conditions. These include when a device requests to join the network, and needs a route to an IAP for authentication and key establishment, and the reverse routes are established for sending back a route reply and authentication message from the IAP, then the temporary routes are limited in their life time and the traffic to be sent using them. Preferably, the authentication and key management messages are the only traffic which can be delivered along these routes. Once a device has obtained its first security key for the routing protocol, it can re-initiate a route request for that temporary route with the secured routing messages. Once the secured route is created, the corresponding temporary route will be deleted from the routing tables.

Thus, the temporary route establishment will not change the normal secured route maintenance. The temporary unsecured route mechanism will limit security risk in the routing of unsecured devices. As an example, a new joining device may be a malicious device which pretends to be another authorized device in the network. In accordance with the present invention, the only message that can be sent without the security extension is the RREQ to the IAP. When a temporary route is set up between the malicious device and the IAP, only the authorized device can pass the authentication and get the routing key, hence even the temporary route is set up, the malicious node can not get the key to participate the future routing activity. Consequently, it can not make any attacks as described herein. Conversely, if the new joining device is an authorized device and it is trying to establish a temporary route, the malicious device can cause this operation either to be unsuccessful or cause a wrong temporary route to be established if the malicious device is the next hop of the new joining device. The joining device will fail at initial authentication to the IAP with the wrong temporary route. The new device will try to use a different neighboring device to establish the initial temporary route until all the neighboring devices are queried. If there is at least one authorized neighboring device, the new joining device establish a true temporary route to the IAP.

Ideally, all the routing messages can be protected with the security extension. Hence, the need for the temporary route requires the limited unsecured routing messages which apply the following rules:

1 All the Route Error (RERR), Hello Message messages should be secured and shall be discarded if they are not secured or fail a security checkup;

2) The unsecured Route Request (RREQ) can only be originated from the new devices before joining the network. And the unsecured Route Reply (RREP) can only be used to response to the unsecured RREQ messages. Other RREQ and RREP should be secured.

By enforcing these rules, the risk of attacks as described herein will be eliminated. The keys used for securing routing messages are generated in a key distribution center (KDC). The KDC is located in the wired network as in FIG. 1 and the secure channels are maintained between the KDC and all the IAPs. The KDC will generate indexed keys periodically and send them to the IAPs which then forward them to all associated wireless devices. The indexed keys are activated at scheduled time starting at the IAPs.

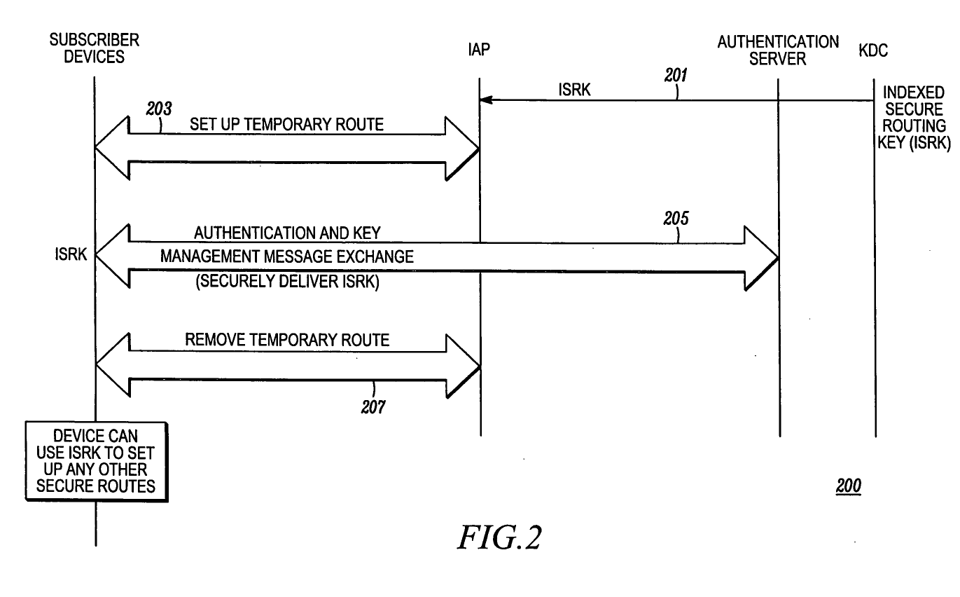

FIG. 2 is a diagram illustrating the method used for set-up of a temporary route and exchange of key management information in accordance with an embodiment of the invention. Initially, an indexed secure routing key (ISRK) is sent in a communication between the key distribution center (KDC) and the internet access point (IAP). Once a temporary route is established between a wireless device either a wireless router or a subscriber device and IAP, the wireless device can transmit authentication and key management messages where it subsequently receives a key management message 205. This enables the ISRK to be securely delivered to the device. The temporary route is then removed and the wireless device can use the ISRK to set up any other secure routes with any devices which have also obtained ISRK.

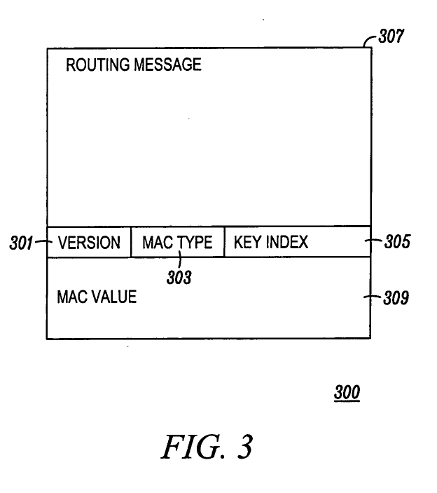

FIG. 3 illustrates a diagram showing a routing message 300 with a security extension. Those skilled in the art will recognize that utilization of an indexed key generation and distribution allow for periodical key refreshment. The re-keying is a fundamental security practice that helps against potential weaknesses of the function and keys, and limits the damage of an exposed key. In addition to the Message Authentication Code (MAC) generated with the key, the key index and algorithm type used to generate MAC are included in each secured routing message as shown in FIG. 3. Those skilled in the art will further recognize that Version 301, MAC type 303 and Key Index 305 will be included with the message 307 and protected together by the MAC value 309. Thus, the verifying device will use the corresponding key based on the key index. If the key index in the received message is higher than the currently used key by the receiving device, the receiving device will initially use the key in the received message as the working key. If the key index in the received message is higher than the highest key index of the receiving device, the receiving device will send a key update request to the associated IAP in order to obtain the current and most recent keys.

To summarize, the present invention identifies the security risks in the on-demand routing protocol, where a novel key management method is used to secure the on-demand routing and its variances in a wireless mesh network. This is accomplished by securing on-demand routing deployed in an infrastructure-based mobile multi-hop wireless networks. The method exploits particular features of the target routing protocols by restricting the usage of certain more vulnerable messages in the initial key setting up stages. Both secured routes and temporary route types are defined based on whether or not the secured routing messages are used in the route discovery. The temporary routes are only used for performing authentication and secure routing key initialization between the unsecured wireless device and an Internet Access Point (IAP).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for secure routing key management for secure on-demand routing protocols for use in a multi-hop wireless network comprising the steps of:
communicating at least one secure routing key from a central location to an access node;
establishing a temporary data route between a wireless device and the access node;
exchanging an authenticated message from the wireless device and the access node;
sending a secure routing key from the access node to the wireless device; and
terminating the temporary route between the wireless device and the access node.

2. A method for secure routing key management as in claim 1, further including the step of:
establishing a permanent data route between the wireless device and the access node after the secure routing key is received by the wireless device.

3. A method for secure routing key management as in claim 2, further including the step of:
utilizing the routing key to establish additional permanent data routes between the wireless device and at least one other wireless device with the same secure routing key.

4. A method for secure routing key management as in claim 1, wherein the central location is a device for generating secure routing keys.

5. A method for secure routing key management as in claim 4, wherein the central location is a key distribution center.

6. A method for secure routing key management as in claim 1, wherein the authenticated message is routed only along the temporary data route.

7. A method for secure routing key management as in claim 1, wherein the temporary data route expires after a predetermined time period.

8. A method for secure routing key management as in claim 1, wherein the temporary data route is stored in a routing table for limited usage by other nodes in the wireless communications network.

9. A method for managing secure routing keys for on-demand routing protocols used in a wireless mesh network comprising the steps of:
sending a secure routing key from a key distribution device to at least one access node;
initiating a temporary communications link between at least one wireless device and the at least one access node when the wireless device initially joins the network;
sending a secure routing key from an access node associated with the key distribution device to the wireless device;
establishing a permanent communications link with the access node; and
sending a message from the wireless device to the at least one access node to terminate the temporary communications link.

10. A method for managing secure routing keys as in claim 9, further including the step of:
utilizing the secure routing key to initiate additional permanent communications routes with at least one other node on the network.

11. A method for managing secure routing keys as in claim 9, wherein the temporary communications link is unsecured.

12. A method for managing secure routing keys as in claim 9, wherein the temporary communications link has a predetermined span of usage.

13. A method for managing secure routing keys as in claim 9, wherein the temporary communications link includes both a forward and reverse route.

14. A method for the management of secure routing keys used with on-demand routing in a wireless communications network comprising the steps of:
sending an indexed secure routing key from a key repository node to a network access point node;
establishing a temporary communications route between a wireless node and the network access point node;
exchanging an authentication message between the wireless node and at least one network server node using the temporary communications route;
delivering a secure routing key from the server node to the wireless node using the temporary communications route;
establishing a permanent communications route to the server node based on the secure routing key; and
disabling the temporary communications route with the network access point node.

15. A method for the management of secure routing keys as in claim 14, wherein the temporary communications route includes both a forward and reverse communications link.

16. A method for management of secure routing keys as in claim 14, wherein the temporary communications route expires in a predetermined time period.

17. A method for management of secure routing keys as in claim 14, wherein the temporary communications route is stored in a routing table for the limited usage by other nodes in the wireless communications network.

18. A method for management of secure routing keys as in claim 14, wherein the wireless node utilizes the secure routing key to establish other secure routes with additional wireless nodes which have obtained the same secure routing key.
